(19) United States
(12) Patent Application Publication
(10) Pub. No.: US 2019/0264501 A1
(43) Pub. Date: Aug. 29, 2019

(54) TENSIONER AND SAFETY ENCLOSURE FOR WINDOW BLIND HOOP DRIVE AND CHANNEL CUT OUT

(71) Applicant: MAXXMAR INC., Toronto (CA)

(72) Inventor: Norbert Marocco, Toronto (CA)

(21) Appl. No.: 16/286,316

(22) Filed: Feb. 26, 2019

Related U.S. Application Data
(63) Continuation of application No. 62/635,079, filed on Feb. 26, 2018.

(51) Int. Cl. E06B 9/324; E06B 9/42; E06B 9/56; F16G 11/10; E06B 9/322

(52) U.S. Cl. CPC E06B 9/324; E06B 9/42; E06B 2009/425; F16G 11/101; E06B 9/322; E06B 9/56

(57) ABSTRACT

The invention relates to a tensioning device for tensioning an endless loop control element in a window blind and particularly relates to a blind operating mechanism and an endless loop blind control element for operating the blind mechanism and having: a channel extending from an upper end to a lower end, with the endless loop blind control element enclosed within the channel; a connector supporting the upper end of the channel adjacent to the blind operating mechanism; and, the tensioning device on the lower end of the channel. The invention also discloses a narrow profile control element having a sprocket wheel with the channel, connector and tensioning device.

### FIELD OF THE INVENTION

The invention relates to a tensioning device for tensioning an endless loop control element in a window blind and particularly relates to a blind operating mechanism and an endless loop blind control element for operating the blind mechanism and having; a channel extending from an upper end to a lower end, with the endless loop blind control element enclosed within the channel; a connector supporting the upper end of the channel adjacent to the blind operating mechanism; and, the tensioning device on the lower end of the channel. In one embodiment the channel has a cut out to access the endless loop control element; in another embodiment the channel includes a pusher to push out a portion of the endless loop out of the channel.

The invention also discloses a narrow profile control element having a sprocket wheel with the channel, connector and tensioning device.

### BACKGROUND OF THE INVENTION

Blinds for building openings, eg windows, doors and the like, may be operated either simply down and up, in the case of eg. roller blinds, or in the case of eg. vertical shade panels, the vertical shade panels may be rotated open or closed.

The control elements for these blind operations are usually in the form of an endless cord or chain. The control element simply hangs down along one side of the building opening, in an endless loop.

Other forms of blinds and window coverings may also be operated by means of an endless control element hanging in a loop.

In the past this system has been used. In some cases a pendant weight was located on the loop to assist in controlling it. In U.S. Pat. No. 8,539,645 Inventor Mario Marocco showed an earlier form of a lock for a blind cord loop in which a spring operated lock is used.

However building codes are now requiring that the endless loop type of control element be guided and controlled at its lower end; and also be tensioned. so as to attempt to prevent the possibility of the element creating a hazard to children, handicap persons or pets. Accordingly it is desirable to provide improved tensioning devices.

Furthermore and generally speaking clutch mechanisms have been used in the window covering industry to inhibit the unwanted unrolling of window blinds. These clutch mechanisms have generally been used with sprocket wheels located at the end of window blinds. However there is a need to minimize the gap between the end of the blind and window frame to minimize the amount of unwanted light infused into a room. Generally speaking the use of spur gears and worm or bevel gears have not been widely used as they tend to increase the gap between the end of the window shade and window frame. Moreover there is a further need to minimize the thickness of a sprocket wheel. Attempts to reduce the thickness of such drives tended to produce a drive that flexed and wandered, and they tended to “bind” when used.

Moreover there is great interest to provide a child safe environment so that it is desirable to use a single rod mechanism to activate the gear drive in a window shade.

For example U.S. Pat. No. 5,752,558 illustrates a tensioning device is to be used with a control cord of a blind assembly and includes a hollow casing which confines a vertically extending receiving space and which has an open top end portion and a bottom end provided with a pivot portion. A pivot unit mounts rotatably the pivot portion of the casing on a wall body. A cord engaging unit has a pulley formed with a cord engaging groove for passing over of the control cord, and a base slideably provided in the receiving space and having a front side formed with a pulley receiving recess. The pulley is mounted rotatably to the base in the pulley receiving recess. The base further has a top wall formed with a pair of notches which permit extension of parallel sections of the control cord that passes over the pulley. A cover member is mounted on the open top end portion of the casing, and is formed with a pair of slits that are aligned with the notches in the top wall of the base and that permit extension of the parallel sections of the control cord therethrough. A force generating member is provided in the receiving space and forces the base of the cord engaging unit downwardly in the casing in order to permit tensing of the control cord when the casing is mounted on the wall body.

Another arrangement is shown in U.S. Pat. No. 5,845,696 which shows a blind cord safety device for use in controlling an adjustable blind having a looped control cord and a looped control chain by enclosing the loops has housing within which are disposed a rotatable wheel adapted to engage the chain loop thereabout and a U-shaped cord loop receiver adapted to receive the cord loop in a peripheral groove formed thereon. The receiver is mounted within the housing so as to permit limited longitudinal but not lateral movement of the receiver within the housing. A spring is disposed within the housing between the receiver and the housing top so as to normally urge the receiver away from the housing top so as to avoid slack in the cord as a result of the cord stretching over time as a result of use.

Also U.S. Pat. No. 7,114,544 describes a tensioner for the control element of a covering for an architectural opening includes a base member attachable to a support surface adjacent to the architectural opening with the base member supporting an upstanding plunger about which a surrounding housing is adapted to slide. A coil spring biases the housing downwardly relative to the plunger and a rotatable pulley is mounted in an open top of the housing around which an endless operating element for a covering for an architectural opening extends.

Applicant has also filed a previous patent application for a tensioner which has been allowed. The tensioner described herein has a funneled upper end to draw the endless loop together so as to make it more difficult to access the endless loop.

These and other prior art devices and blind controls attempt to block out the light coming from outside the window particularly when a person desires to sleep.

It is an object of this invention to provide an improved blind control for a window covering.

It is another object of this invention to locate the drive mechanism to minimize the gap between the end of the window shade and window frame.

Yet another object of this invention relates to the use a single rod means depending from the control module to activate the drive mechanism in a safe and secure manner.

It is another object of this invention to provide a narrow profile control module for a window shade to minimize light from outside the window infiltrating the room.

### SUMMARY OF INVENTION

It is an aspect of this invention to provide a spring loaded tensioning device for tensioning an endless loop blind control element to be secured in position on a window opening; comprising; a housing for housing said endless loop blind control element; a hinged flap portion on said housing, said hinged flap portion being operable between an open position for insertion of a portion of the control element into said housing and a closed position for securing the control element in said housing; a funnel portion on said housing for drawing said endless loop together.

In one embodiment the housing comprises a first shell portion and a second shell portion, and wherein one of shell portions presents said hinged flap. In another embodiment the first and second shell portions engage each other to present an upper end and a lower end and define a cavity therein and wherein the hinged flap portion is disposed in said upper end of one of said first or second shell portions. Another embodiment presents a spring loaded tensioning wherein said funnel portion is disposed in said upper end. In yet another embodiment there is a moveable lock in the housing shell, moveable between a locking position in which it clamps onto said element, and a released position in which said lock is free of said control element.

It is also an aspect of this invention to provide a blind operating mechanism and an endless loop blind control element for operating the blind mechanism and comprising; an enclosure extending from an upper end to a lower end, with the endless loop blind control element enclosed within the enclosure between the upper end to the lower end of said enclosure; a connector supporting the upper end of the enclosure adjacent to the blind operating mechanism and depending downwardly from it; and, a tensioning device on the lower end of the enclosure for tensioning the endless loop control element.

In one embodiment of the invention the enclosure comprised a channel extending between said upper end to said lower end for containing said endless loop blind control element within said channel.

In another embodiment the channel includes a pusher means for pushing a portion of said endless loop blind control element out of said channel between an operable position for manipulating said endless loop blind control element to move a blind and a retracted position whereby the pusher means and said portion of said endless loop blind control element retracts back into said channel.

The channel has an open side and further includes a cover to cover said open side of said channel from said upper end to said lower end.

In one embodiment the channel includes the pusher means for pushing a portion of said endless loop blind control element out of said channel between an operable position for manipulating said endless loop blind control element to move a blind and a retracted position whereby the pusher means and said portion of said endless loop blind control element retracts back into said channel, and the cover includes an aperture aligned with said pusher means to receive said portion of said endless loop blind control element.

The endless loop blind control element can either be a chord or chord and ball chain or the like.

In one aspect the tensioning device includes a housing having a hinged portion being operable between an open position for insertion of another portion of said endless loop blind control element and a closed position for securing the element in the tension device. In one embodiment the the tensioning device includes guide surfaces to guide said another portion of said endless loop blind control element there around.

Furthermore the housing comprises a first shell portion and a second shell portion, and wherein one of shell portions includes said hinged portion where the hinged portion comprised a hinged flap and wherein said flap includes a distal portion from said hinged portion to engage said lower end of said channel.

It's another aspect of this invention to provide a blind having a blind operating mechanism and an endless loop blind control element for operating the blind mechanism and comprising; an enclosure for the blind control element, the enclosure defining an upper end and a lower end with the element concealed within the enclosure from the upper end to the lower end; a connector supporting the upper end of the enclosure adjacent to the blind operating mechanism and depending downwardly from it; and a tensioning device on the lower end of the enclosure for tensioning the endless loop control element.

In a further embodiment there is provided a sprocket wheel adjacent one end of said blind and engageable with said endless loop to control the movement of said blind; moreover the blind operating mechanism for the window shade for a window opening has a narrow profile wherein the gap is between 4 to 8 millimeters and said endless loop blind control element is contained out of reach by children.

It is another aspect of the invention to provide a connector for a window blind comprising: a housing having an upper end and a low end, and defining a cavity between said upper end and lower end; said upper end adjacent a blind operating mechanism for receiving a blind loop element from the blind operating mechanism through said upper end, through said cavity and out the lower end, said lower end being smaller than said upper end to bring said loop element closer together. In one embodiment the connector for a window presents a funnel from said upper end to said lower end.

It is yet another aspect of this invention to provide a stopper for an open channel receiving an endless loop element therein, said stopper moveable relative said channel to limit the extension of said endless loop from said channel.

It in another aspect of this invention to provide a channel which includes a cut out structure carried by the channel for accessing the endless loops control element out of said channel in an operable position for manipulating said endless loops blind control element to move a blind, and to release the endless loops blind control element whereby the endless loop blind control element retracts back into the channel.

These and other objects and features shall now be described in relation to the following drawings.

### IN THE DRAWINGS

FIG. 1 is a perspective view of a window blind with the tensioning device, channel and connector.

FIG. 1A shows the connector, enclosure and tensioning device.

FIG. 1B shows the connector, a telescoping enclosure and joint.

FIGS. 2a and 2b, 2c, and 2d show the tensioning device first housing shell and second housing shell.

FIGS. 3A and 3B are top views of the tensioning shell halves.

FIGS. 4A, 4B, 4C, 4D are partial perspective view of the channel showing a pusher means, with and without a cover.

FIG. 4D in another embodiment of the channel showing a cut out.

FIGS. 5A and 5B show the tensioning device engage the lower end of the channel while FIG. 5C shows the cover in perspective cross section.

FIG. 6 is a perspective view of the connector engaging the upper end of another embodiment of the enclosure.

FIGS. 7A, 7B and 7C are views showing the endless loop engaging a sprocket wheel where the endless loop is guided through a connector, and another embodiment of telescoping channels with a connector at the top end thereof.

FIGS. 8A and 8B are cross sections of different embodiments of the channel.

FIG. 9 is a perspective view of the tensioning device

FIG. 10A, 10 B, and 10C are side views of the tensioning device,

### DETAILED DESCRIPTION OF THE INVENTION

Like parts are given like numbers throughout the figures.

Like parts are given like numbers throughout the figures.

### Description of a Specific Embodiment

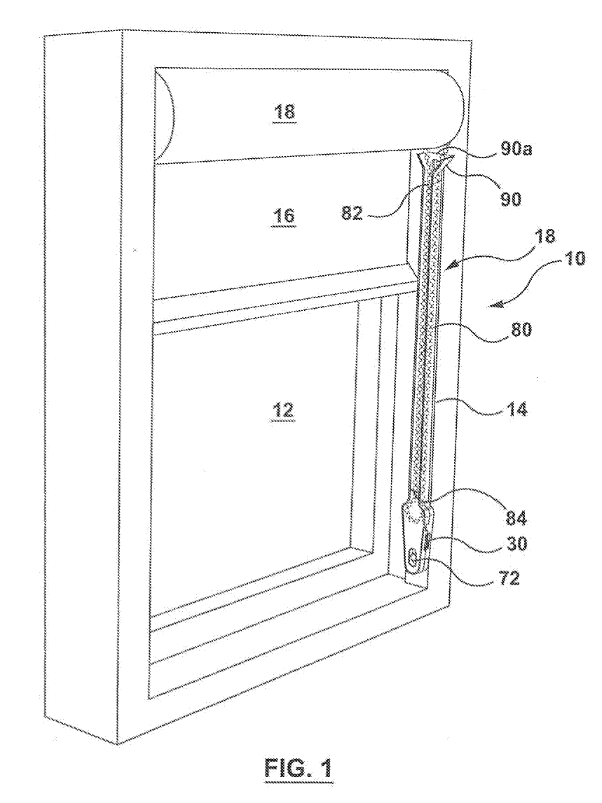

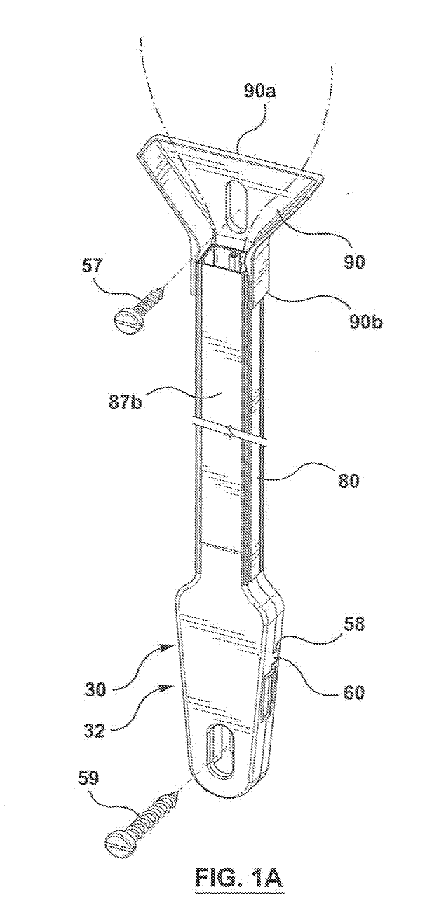

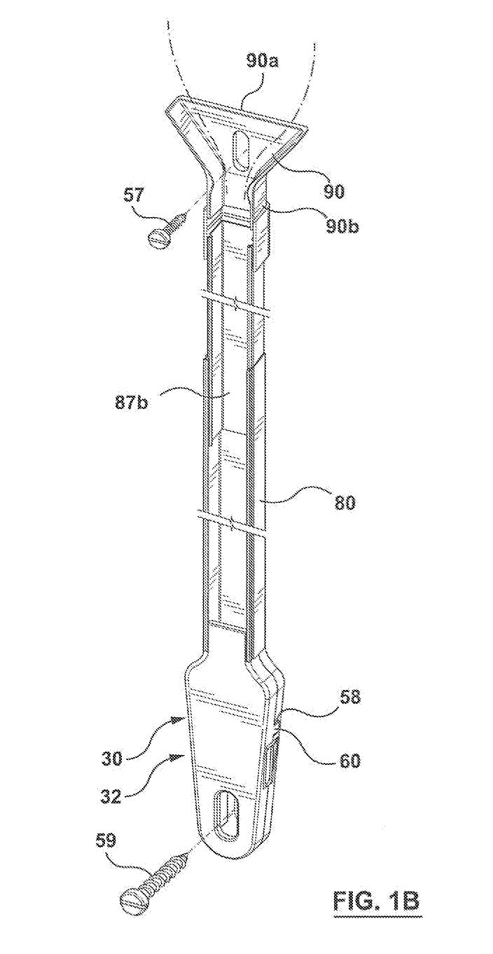

FIG. 1 illustrates a window 10 with an opening 12 and a border 14 which has a window blind 16 adapted to move up and down within the opening 12.

For purposes of illustration FIG. 1 depicts a simple roller blind 18 mounted on the frame 14. The blind 18 has a sheet of suitable material wound upon a roller which may be lowered or raised. The roller is operated by a controlled element depicted generally as 18.

The element 20 can comprise a typical chain type element with a series of balls 22 connected by a wire or cord 24 in a manner well known to those persons skilled in the art. The element 20 may also comprise a cord. The element 20 comprises an endless loop and engages a gear drive in the mechanism of the blind.

The roller blind is shown by way of example as various other forms of blinds employ a continuous loop type of control element 20 and the invention to be described herein is applicable to all of them and is not confined solely to the roller blind as shown.

Moreover different forms of drive mechanisms can be used and the invention is described herein as applicable to a variety of forms of control elements that utilize ball and chain or cord mechanisms.

Recent building codes require that the endless loop be held in tension between the blind at the upper end and a tension device 30 at the lower end thereof as a safety feature.

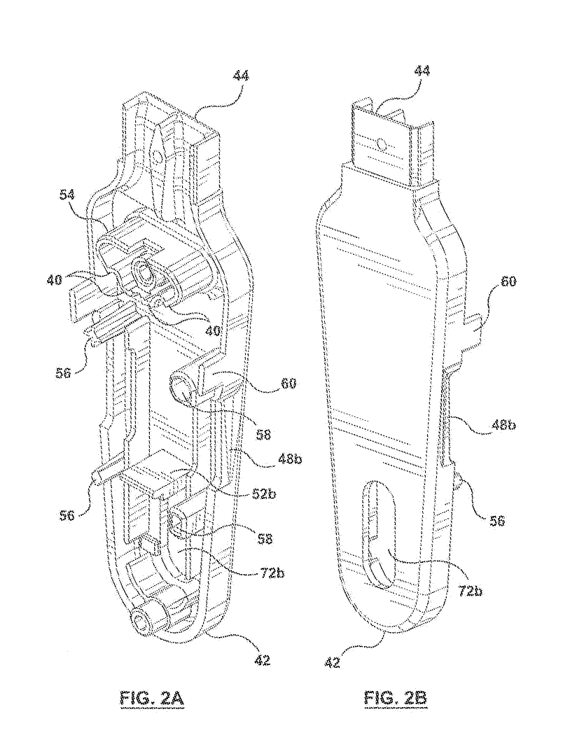

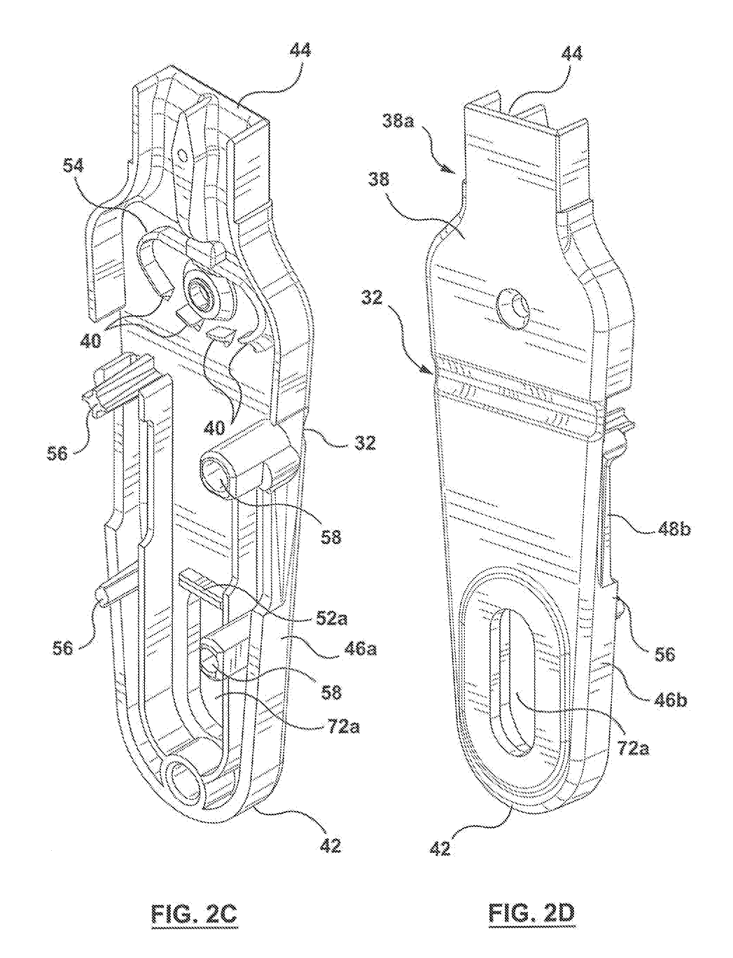

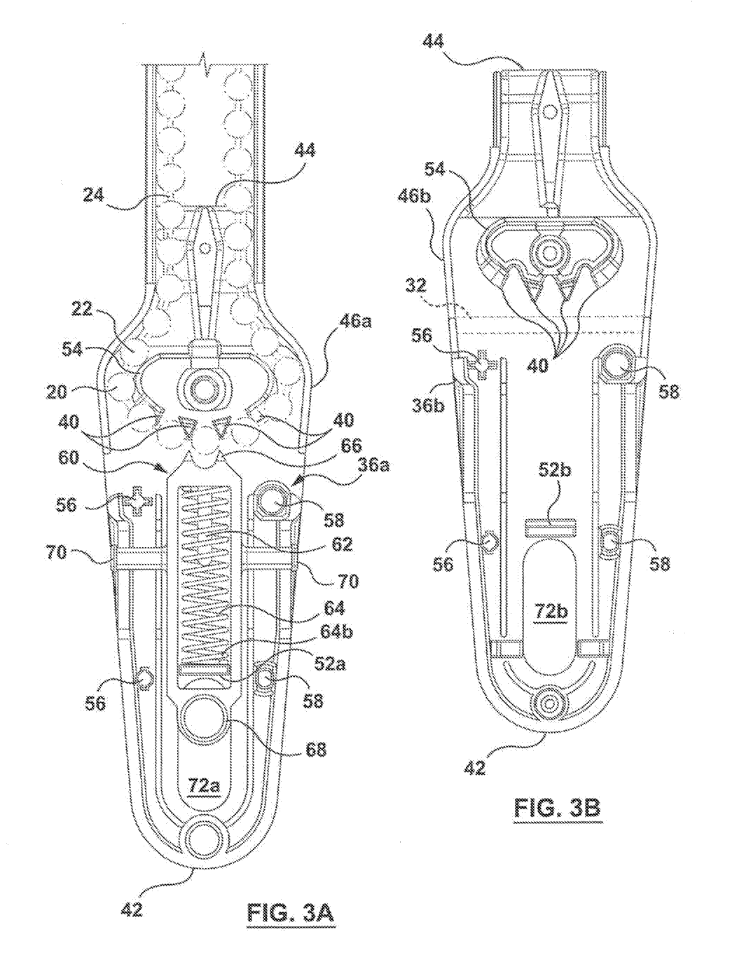

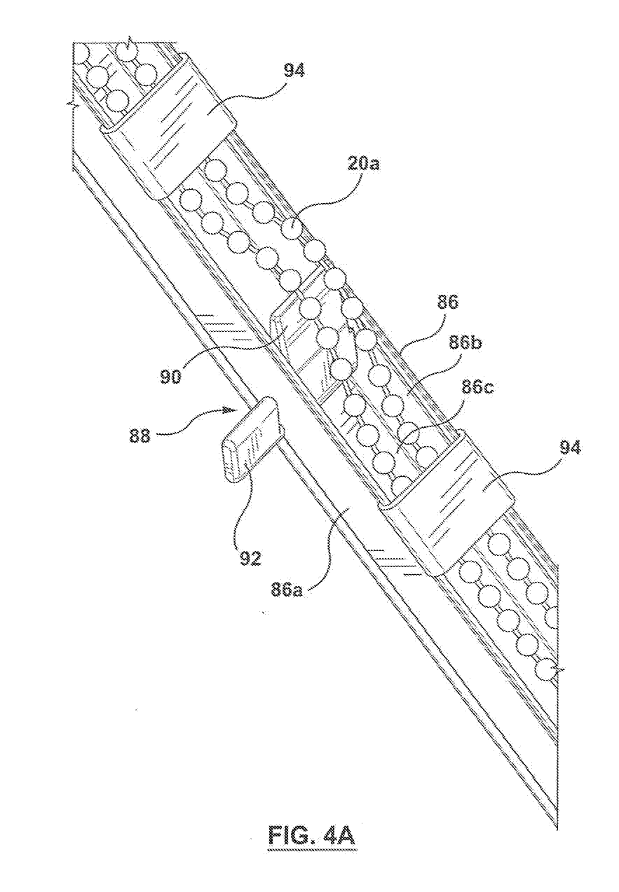

The tension device 30 is shown in more detail in FIGS. 1A, 2A, 3B, as well as FIGS. 3A and 3B.

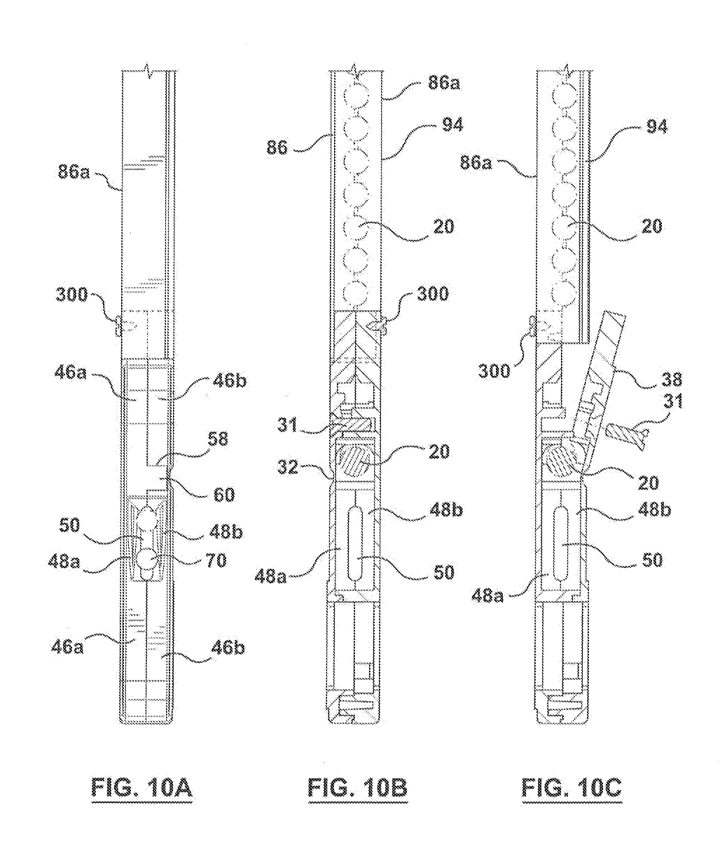

The tensioning device 30 comprises a housing 32 having a hinged portion 38 being operable between an open position as shown in FIG. 10C for insertion of a portion of the endless loop blind control element 20 and a closed position as shown in FIG. 10B for securing the element 20 in the tension device 30. More particularly the housing 32 comprises a first shell portion 36A and second shell portion 36B as shown in FIGS. 3A and 3B and wherein one of the shell portion includes the hinged portion or hinged flap 38.

Furthermore the tension device 30 includes guide surfaces 40 to guide a portion of the endless loop blind control element 20 there around.

The first shell portion 36A and second shell 36B can be formed from synthetic plastic or other suitable material and have upper and lower ends 42 and 44 respectively. The lower end 42 displays generally semi-circular profile as shown. Each shell portion 36A and 36B include upstanding sidewalls 46A and 46B and extend from the lower end 42 upwardly and terminate adjacent the upper end 44. The upstanding sidewalls 46A and 46B present reduced height portions 48A and 48B so as to define an opening 50.

The housing 32 and in particular the first shell portion 36A and second shell portion 36B define a cavity there between.

Each shell housing portion 36A and 36B includes a support ledge 52A and 52B which cooperate to contact each other once the first shell housing portion 36A and second shell housing portion 36B register with each other.

Located at the upper end 44 of the first shell housing portion 36A and second shell housing portion 36B and spaced from the upstanding side walls 46A and 46B is a fixed hub 54 which presents the guide or glide surfaces 40 around which the control element 20 can freely slide. The hub 54 acts like a pulley though it is stationery.

Each first and second shell hub housing portion 36A and 36B present post or plug 56 that register with receiving holes 58 so that the two halves can snap together. One of the housing shells 36A and 36B include a notch 58 that is adapted to receive a tab 60 as best seen in FIG. 1A so as to help to register the first and second shell housing 36A and 36B together.

Adjacent the upper end 44 of one of the shell housing units 36A and 36B is a flexible self-hinge groove 34 defining the hinge so as to permit the flap 38 to be opened and closed as previously described. This allows the upper end 44 of the second shell housing 36B to be flexed outwardly and inwardly like a flap to enable service persons to install the element 20. Also it permits a person to mount the tensioner 30 onto an existing window blind having an endless loop 20 without having to dismantle any of the existing hardware. Thus the tensioner 30 can be used as a retrofit item into existing window blind hardware.

A captive slide lock 60 is located within the housing 30. The slide lock 60 includes a spring guide rod 62 which receives and guides a spring 64. One end of the spring 64A abuts against the upper inner end of the slide lock 60 while the opposite end 64B abuts against the ledge 52A and 52B.

At the other end of the slide lock 60 there are optionally one or two upstanding rows of teeth 66 or engaging means 66. The teeth 66 or element engaging means 66 are presented so as to engage with the element 20 when it passes over the hub 54 to prevent the element 20 from passing around the hub 54 and lock it into place. Furthermore the engagement means 66 or teeth 66 act as another layer of safety as the teeth 66 will “bite” the control element 20 if the tensioner 30 is not secured to the window frame 14 by fastener 59 (see FIG. 1A as the spring 64 will expand and cause the “teeth” to bite into the endless loop 20 and prevent the endless loop from moving until properly secured. Alternatively the slide lock 60 may eliminate teeth 66 and present a surface to contact the endless loop. In yet another embodiment the engaging means 66 and slide lock 60 may be eliminated.

At the opposite end of the slide lock 60 there is screw housing sleeve 68 which permits a screw fastener 59 to be passed there through. A pair of finger buttons 70 extend outwardly from a slide lock 60 passing through the holes 50.

In order to secure the tension device 30 to the window frame 14 a screw 59 is received through the screw receiving slot 72 as shown in FIG. 1. Each shell housing 36A and 36B includes a screw receiving slot 72A and 72B respectively. The fastener 59 that passes through the screw receiving slot 72 also passes through the screw housing sleeve 68 of the slide lock 60 as shown.

In operation the serviceperson would manipulate the finger button 70 and slide the slide lock 60 downwardly compressing a spring 64 so as to open the space around the hub 54. Thereafter a portion of the loop of element 20 is placed around the hub 46 for contact with the guides 40.

Thereafter the flap 38 is closed and the finger buttons 70 released. The slide lock 60 will react when the pressure of the spring 64 and the teeth or element engaging means 66 will grip the element 20 against the hub 54.

The tensioner 30 in one embodiment can be used by itself as the tensioner 30 includes side wall 46a and 46b that converge toward each other in the vicinity of the upper end 44 so as to “funnel” the endless loop 20 together, and more particularly endless loop portion 20a and 2b “close together”. In another embodiment the invention comprises the tensioner in combination with the connector 90.

Furthermore the connector 90 presents a wider opening at the top 90a thereof than the lower open end 90b so as to “funnel” the endless embodiment the invention comprises a connector 90 for receiving the loop ‘together’ making it more difficult to get between the elements 20a and 20b. In one embodiment the invention comprises a connector adjacent a blind control mechanism for receiving the endless loop into an opening at the upper end 90a thereof through said connector and out the lower end 90b thereof, the lower end being smaller than the upper end thereof so as to “funnel” or bring the endless loop 20a and 20b closer together than when entering the upper end 90a so as to bring the loop elements closer together. Accordingly the invention includes using the connector by itself, or alternatively using the connector 90 in combination with the tensioner 30, or alternatively the combination of the tensioner 30, enclosure 80 and connector 90.

The blind operating mechanism 18 also comprises an enclosure 80 extending from an upper end 82 to a lower end 84 with the endless loop button control element 20 enclosed within the enclosure 80 between the upper end 82 and the lower end 84 of the enclosure 80.

The blind operating mechanism 18 also includes a connector 90 supporting the upper end 82 of the enclosure 80 adjacent to the blind operating mechanism and depending downwardly from it.

The tension device 30 is located at the lower end 84 of the enclosure 80 for tensioning the endless loop control element 20.

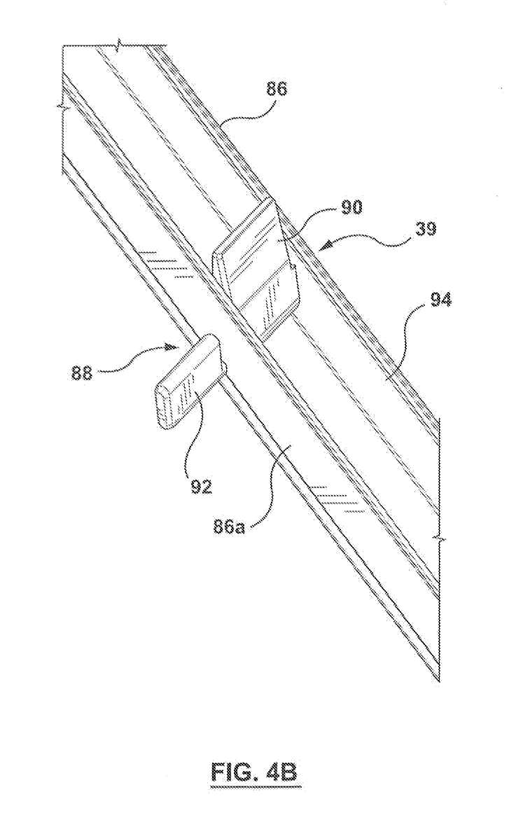

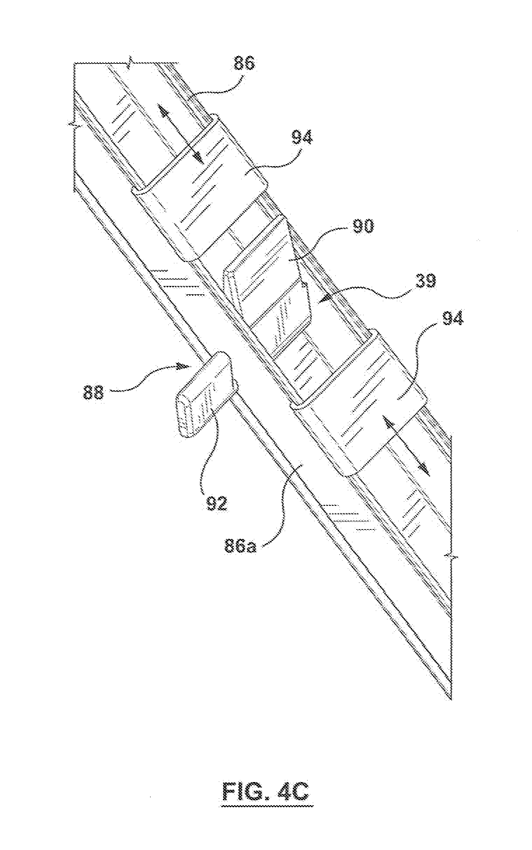

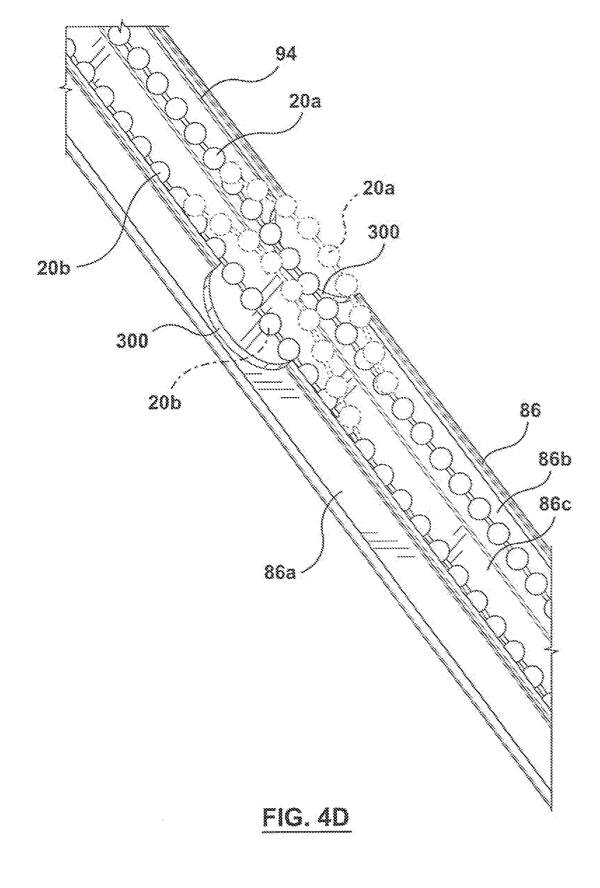

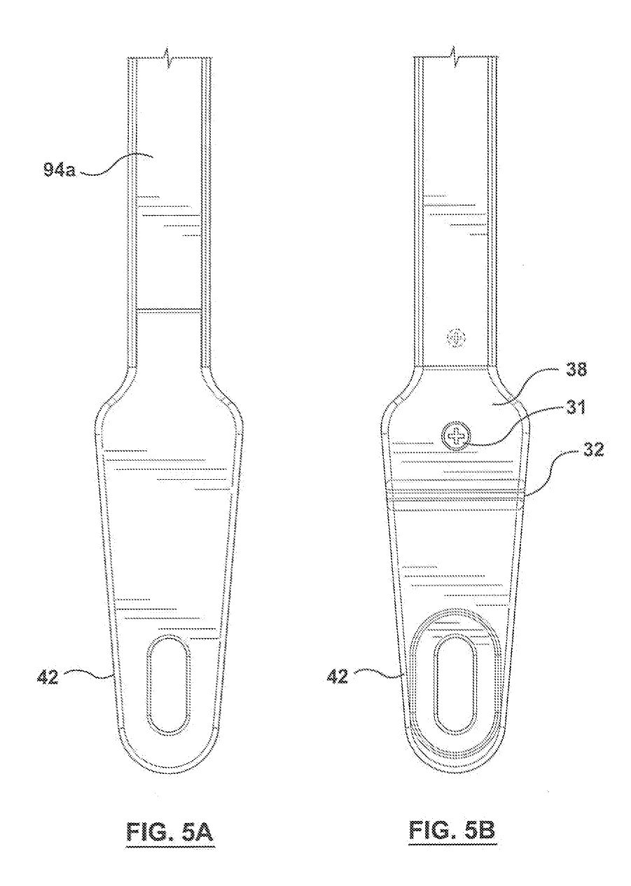

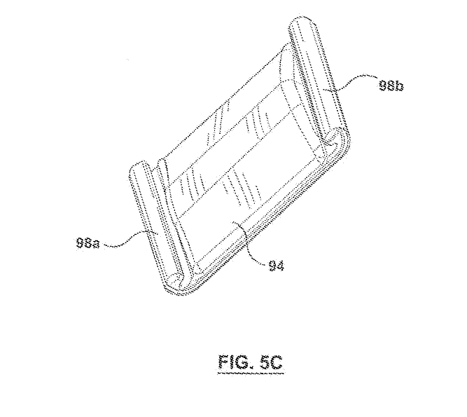

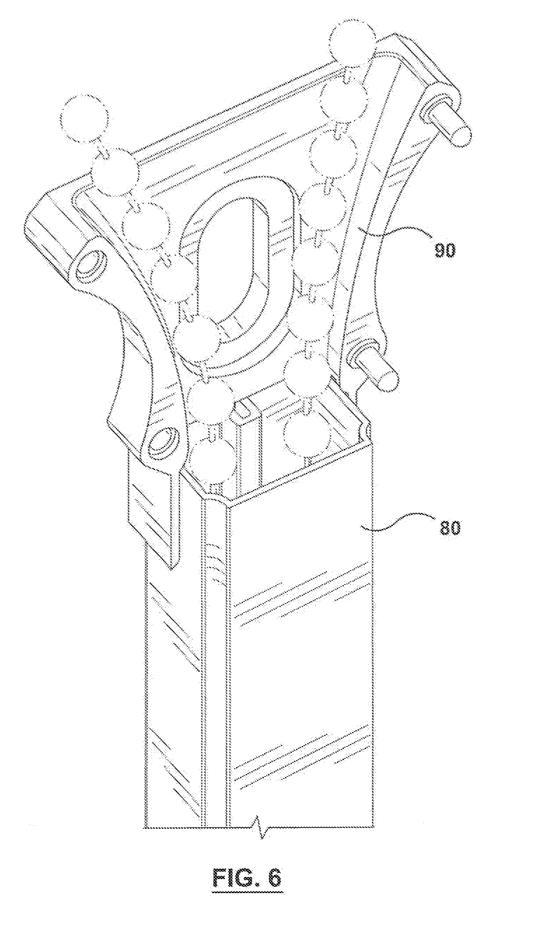

The enclosure 80 comprises a channel 86 as shown in FIGS. 4A, 4B, and 4C which channel extends between said upper end 82 and said lower end 84 for containing the endless loop blind control element 20 within the channel 86.

The channel 86 includes a pusher means 88 as best in FIGS. 4A and 4B. The pusher means 88 comprises a paddle surface 90 that can be moved by moving element or handle 92 connected to the paddle 90 by means of a shaft that extends through one of the sidewalls 86A and 86B. The channel also includes a bottom wall 86C. Accordingly the pusher means 88 pushes a portion of the endless loop blind control element 20 out of the channel between an operable position for manipulating the endless loop blind control element 20 to move the blind up and down; to a retracted position whereby the pusher means 88 and a portion of the endless loop blind control element 20 retracts back into the channel 86 between the sidewalls 86A and 86B down towards the bottom wall 86C.

More particularly the pusher means 90 pushes two portions 20a and 20b of the endless loop 20 out of the enclosure or channel 80 in the operable position. Thus a person will have the choice ton either move the portion 20a so as to move the blind 16 either up or down or to move the other portion 20b so as the move the blind 16 in the opposite direction ie either down or up.

FIG. 4D illustrates yet another embodiment of the invention which relates to a blind operating mechanism wherein said channel includes a cut out means 300 carried by said channel 86 for accessing said endless loop control element 20a am 20b out of said channel 86 in an operable position for manipulating said endless loops blind control element 20 to move a blind, and to release the endless loop blind control element whereby the endless loop blind control element retracts back into the channel, so as to present a safe device.

As can be seen the channel 86 includes an open side. Furthermore the operating mechanism may also include an adjustable stopper or limiter, 94 that is moveable along the open end of the channel 80 from the upper end 82 to the lower end 84 so as to be able to adjust how far or how much of the endless loop 20 and particularly the portions 20a and 20b are presented outside the channel walls 86a and 86b and thus provide and added safety feature to the blind operating mechanism. For example if the stopper 94 is presented close to the pusher means 88 then a smaller portion of the endless loop 20a and 20b is exposed as compared to moving the stopper means 94 further away from the pusher means 90. In other words the stopper or limiter is a safety device that limits the extension of the loop beyond the enclosure 80.

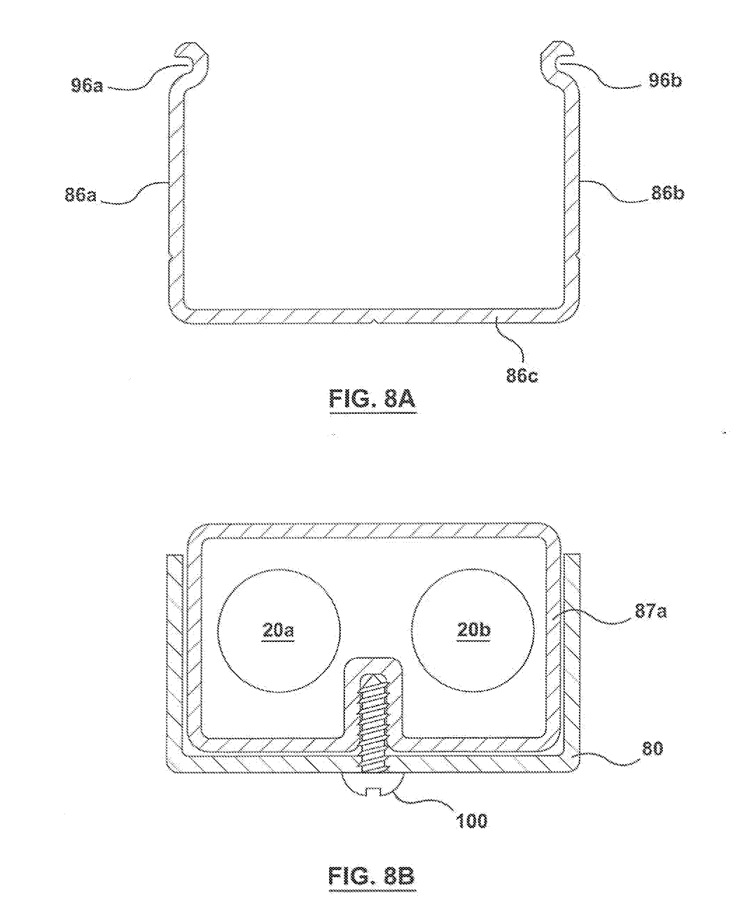

The channel in one embodiment as shown in FIG. 8A includes a recess 96A and 96B at the upper ends of the sidewalls 86A and 86B respectively. The recesses 96A and 96B are adapted to receive projections 98A and 98B of stopper 94 so as to snap the stopper 94 onto the channel 86.

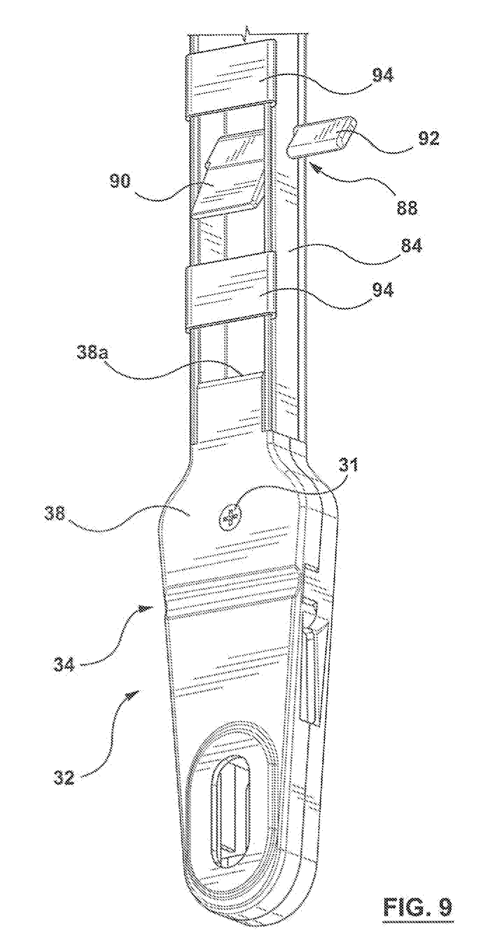

The hinge portion 34 defines a hinge flap 38 which has a distal portion 38A for engaging with the lower end 84 of the channel 86 as shown in FIG. 9 and “snaps” into place.

The invention as described relates to a blind 18 having a blind operating mechanism 18 and an endless loop blind control element 20 for operating the blind 18 and comprises:
(a) an enclosure 80 for the blind control element 20, the enclosure 80 defining an upper end 82 and a lower end 84 with the element 20 concealed within the confines of the enclosure 80 from the upper end 82 to the lower end 84;
(b) a connector 90 supporting the upper end 82 of the enclosure 80 adjacent to the blind operating mechanism and depending downwardly therefrom; and
(c) a tension device 30 at the lower end 84 of the enclosure 80 for tensioning the endless loop control element 20.

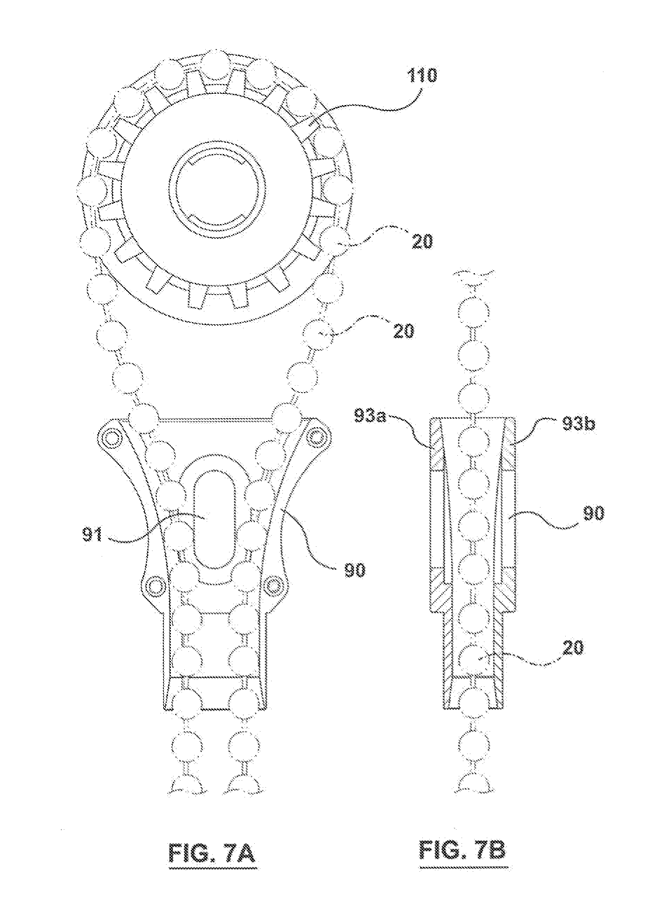

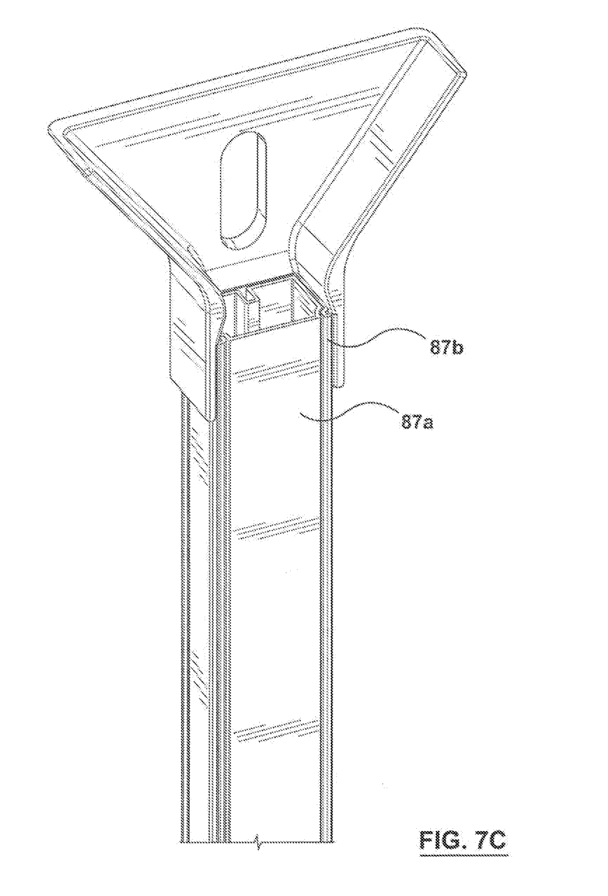

The channel 86 also comprises telescoping first and second channel portions 87A and 87B as shown in FIG. 7C. In the embodiment shown in FIG. 7C, 87a has the profile shown in FIG. 8B while 87b has the profile shown in FIG. 8A. However this is just one example of a telescoping enclosure 80 and other profiles may be used.

Alternatively the telescoping portions 87A and 87B may have the cross-sectional profile as shown in FIG. 8B which can be secured together at the appropriate telescopic length by utilizing a fastener 100 that extends between the first telescoping channel 87A towards the second telescoping channel 87B by means of extending through a ridge portion 87C presented by the second telescoping channel 87B.

The channel 80 may be manufactured and sold in pre-selected lengths, for example 3 feet. The tensioner 30 can also be sold separately or as a kit with the connector 90 for the retrofit market. The channel can be made from plastic aluminum, metal or other suitable material and cut to any desired length. If the widow height is larger than the pre-selected length of the channel 80 then a telescoping length of enclosure 87A may be utilized with the channel 80; once adjusted to the desired length the telescoping members 80 and 87a may be secured by fastener 100.

If the height of the window is extremely large a joint 200 as shown in FIG. 1B can be used to join telescoping member 87a to connector 90.

The connector 90 which supports the upper end 82 of the channel 86 comprises a connector upper end 90a to guide the endless loop 20 towards the channel 86 and a connector lower end 90b to engage with the upper end 82 of the channel 86. The connector 90 is funnel shaped and funnels the endless loop close together at the lower end so as to present the endless loop 20a and 20b close together to inhibit access to the endless loop 20.

Although the invention has been described in one embodiment or example to be well suited to a retrofit market, the invention is also applicable as product for a new or original widow blind.

The invention as described herein also shows in FIG. 11 the use of a sprocket wheel 110 adjacent to one end of the blind 18 and engageable with the endless loop 20 to control the movement of the blind.

In particular as shown in FIG. 11 there is a blind operating mechanism 18 for a window shade 16 for a window opening 12 comprising:
(a) a control housing disposed at one end of the window shade 18 and the window frame 14 to define a gap there between;
(b) a first cavity presented by the control housing;
(c) a sprocket wheel 110 within said first cavity 112 for moving the window blind 16; (d) an endless blind control element 20 engagable with the sprocket wheel 110;
(e) a channel 86 defining an upper end 82 and a lower end 84 with the endless loop blind control element 20 contained within the channel 86 from the upper end 82 to the lower end 84;
(f) a connector 90 supporting the upper end 82 of the channel 86 to the blind operating mechanism 118 and depending downwardly from it; and
(g) a tensioning device 30 at the lower end of the enclosure 80 for tensioning the endless loop control element 20.

The blind operating mechanism 18 for the window shade 16 using the sprocket wheel 110 defines a narrow profile whereby the gap is between 4-8 millimetres and the endless loop control blind control element 20 is contained out of reach by children.

What is claimed is:

1. A spring loaded tensioning device for tensioning an endless loop blind control element to be secured in position on a window opening; comprising;
a housing for housing said endless loop blind control element;
a hinged flap portion on said housing, said hinged flap portion being operable between an open position for insertion of a portion of the control element into said housing and a closed position for securing the control element in said housing;
a funnel portion on said housing for drawing said endless loop together.

2. A spring loaded tensioning device as claimed in claim 1 wherein said housing comprises a first shell portion and a second shell portion, and wherein one of shell portions includes said hinged flap.

3. A spring loaded tensioning device as claimed in claim 2 wherein said first and second shell portions engage each other to present an upper end and a lower end and define a cavity therein and wherein said hinged flap portion is disposed in said upper end of one of said first or second shell portions.

4. A spring loaded tensioning device as claimed in claim 3 wherein said funnel portion is disposed in said upper end.

5. A spring loaded tensioning device as claimed in claim 4 further including a spring and lock disposed in said cavity for urging said lock to clamp onto a portion of the control element in said housing.

6. A blind operating mechanism and an endless loop blind control element for operating the blind mechanism and comprising;
(a) an enclosure extending from an upper end to a lower end, with the endless loop blind control element enclosed within the enclosure between the upper end to the lower end of said enclosure;
(b) a connector supporting the upper end of the enclosure adjacent to the blind operating mechanism and depending downwardly from it; and,
(c) a tensioning device on the lower end of the enclosure for tensioning the endless loop control element.

7. A blind operating mechanism as claimed in claim 6 wherein said enclosure comprised a channel extending between said upper end to said lower end for containing said endless loop blind control element within said channel.

8. A blind operating mechanism as claimed in claim 7 wherein said channel includes a pusher means for pushing a portion of said endless loop blind control element out of said channel between an operable position for manipulating said endless loop blind control element to move a blind and a retracted position whereby the pusher means and said portion of said endless loop blind control element retracts back into said channel.

9. A blind operating mechanism as claimed in claim 8 wherein said channel has an open side and further including a cover to cover said open side of said channel from said upper end to said lower end.

10. A blind operating mechanism as claimed in claim 7 wherein said channel is comprised of plastic or metal.

11. A blind operating mechanism as claimed in claim 10 wherein said channel includes the pusher means for pushing a portion of said endless loop blind control element out of said channel between an operable position for manipulating said endless loop blind control element to move a blind and a retracted position whereby the pusher means and said portion of said endless loop blind control element retracts back into said channel, and includes a stopper means for engaging the channel to adjust the extent that the endless loop is pushed out of said channel.

12. A blind operating mechanism as claimed in claim 11 wherein said endless loop blind control element is either a chord or chord and ball chain.

13. A blind operating mechanism as claimed in claim 11 wherein said tensioning device includes a housing having a hinged portion being operable between an open position for insertion of another portion of said endless loop blind control element and a closed position for securing the element in the tension device.

14. A blind operating mechanism as claimed in claim 13 wherein the tensioning device includes guide surfaces to guide said another portion of said endless loop blind control element there around.

15. A blind operating mechanism as claimed in claim 14 wherein said housing comprises a first shell portion and a second shell portion, and wherein one of shell portions includes said hinged portion.

16. A blind operating mechanism as claimed in claim 11 wherein said hinged portion comprised a hinged flap and wherein said flap includes a distal portion from said hinged portion to engage said lower end of said channel.

17. A blind having a blind operating mechanism and an endless loop blind control element for operating the blind mechanism and comprising;
(d) an enclosure for the blind control element, the enclosure defining an upper end and a lower end with the element concealed within the enclosure from the upper end to the lower end;
(e) a connector supporting the upper end of the enclosure adjacent to the blind operating mechanism and depending downwardly from it; and,
(f) a tensioning device on the lower end of the enclosure for tensioning the endless loop control element.

18. A blind having a blind operating mechanism as claimed in claim 17 wherein said enclosure comprises a channel having an open side extending from said upper end to said lower end and said element is contained therein.

19. A blind having a blind operating mechanism as claimed in claim 18 further including a cover to cover said open side of said channel.

20. A blind having a blind operating mechanism as claimed in claim 18 wherein said channel comprises a telescoping first and second channel portion.

21. A blind having a blind operating mechanism as claimed in claim 18 wherein said tensioning device engages said lower portion of said channel and comprises a housing having a first shell portion and a second shell portion, and wherein one of shell portions includes a hinged flap being operable between an open position for insertion of another portion of said endless loop blind control element and a closed position for securing the element in the tension device.

22. A blind having a blind operating mechanism as claimed in claim 21 wherein said connector supporting said upper end of said channel comprises a connecter upper end to guide said endless loop toward said channel and a connector lower end to engage said upper end of said channel.

23. A blind having a blind operating mechanism as claimed in claim 22 wherein said housing of said tensioning device includes a spring for tensioning said tension device.

24. A blind having a blind operating mechanism as claimed in claim 23 further including a sprocket wheel adjacent one end of said blind and engageable with said endless loop to control the movement of said blind.

25. A blind operating mechanism for a window shade for a window opening comprising:
(g) a control housing disposed at one end of said window shade and said window opening to define a gap there between;
(h) a first cavity presented by said control housing;
(i) a sprocket wheel disposed within said first cavity for moving said window blind;
(j) an endless loop blind control element engageable with said sprocket wheel;
(k) a channel defining an upper end and a lower end with the endless loop blind control element contained within the channel from the upper end to the lower end;
(l) a connector supporting the upper end of the channel adjacent to the blind operating mechanism and depending downwardly from it; and
(m) a tensioning device on the lower end of the enclosure for tensioning the endless loop control element.

26. A blind operating mechanism for a window shade for a window opening as claimed in claim 25 having a narrow profile wherein said gap is between 4 to 8 millimeters and said endless loop blind control element is contained out of reach by children.

27. A connector for a window blind comprising:
(a) housing having an upper end and a low end, and defining a cavity between said upper end and lower end
(b) said upper end adjacent a blind operating mechanism for receiving a blind loop element from the blind operating mechanism through said upper end, through said cavity and out the lower end, said lower end being smaller than said upper end to bring said loop element closer together.

28. The connector for a window blind as claimed in claim 27 wherein said connector presents a funnel from said upper end to said lower end.

29. A stopper for an open channel receiving an endless loop element therein, said stopper moveable relative said channel to limit the extension of said endless loop from said channel.

30. A blind operating mechanism as claimed in claim 7 wherein said channel includes cut out means carried by said channel for accessing said endless loops control element out of said channel in an operable position for manipulating said endless loop blind control element to move a blind, and to release the endless loop blind control element whereby the endless loop blind control element retracts back into the channel
